(19) United States
(12) Patent Application Publication
(10) Pub. No.: US 2006/0139494 A1
(43) Pub. Date: Jun. 29, 2006

(54) Method of temporal noise reduction in video sequences

(75) Inventors: Zhi Zhou, Irvine, CA (US); Yeong-Taeg Kim, Irvine, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 11/025,173

(22) Filed: Dec. 29, 2004

(51) Int. Cl. H04N 5/21; H04N 5/14

(52) U.S. Cl. 348/607; 348/701

(57) ABSTRACT

A motion-adaptive temporal noise reducing method and system for reducing noise in a sequence of video frames is provided. Temporal noise reduction is applied to two video frames, wherein one video frame is the current input noisy frame, and the other video frame is a previous filtered frame stored in memory. Once the current frame is filtered, it is saved into memory for filtering the next incoming frame. A motion-adaptive temporal filtering method is applied for noise reduction. Pixel-wise motion information between the current frame and the previous (filtered) frame in memory is examined. Then the pixels in the current frame are classified into motion region and non-motion region relative to the previous (filtered) frame. In a non-motion region, pixels in the current frame are filtered along the temporal axis. In a motion region, the temporal filter is switched off to avoid motion blurring.

### FIELD OF THE INVENTION

The present invention relates generally to video processing, and more particularly to noise reduction in video sequences.

### BACKGROUND OF THE INVENTION

In many video display systems such as TV sets, video enhancement by noise reduction is performed in order to obtain noise-free video sequences for display. Various noise reduction methods have been developed, but few are used in real products because such methods introduce unwanted artifacts into video frames. Most of the conventional noise reduction methods can be classified into three categories: spatial (2D) noise reduction, temporal noise reduction, and 3D noise reduction (i.e., combination of 2D and temporal noise reduction).

Spatial noise reduction applies a filter (with a small local window) to every pixel of the current video frame. Such a filter is usually regarded as a convolution filter based on a kernel. Examples of such a filter are the mean filter, the Gaussian filter, the median filter and the sigma filter. Mean filtering is the simplest, intuitive method for smoothing images and reducing noise, wherein the mean of a small local window is computed as the filtered result. Generally, a 3×3 square kernel is used, simplifying implementation. The mean filter, however, causes severe blurring of images.

Gaussian filtering uses a “bell-shaped” kernel to remove noise. Gaussian filtering equivalently is a weighted average operation of the pixels in a small local window. However, Gaussian filtering also introduces blurring (severeness of the blurring can be controlled by the standard deviation of the Gaussian).

Median filtering is a nonlinear method. It sorts the pixels in a small local window and takes the median as the filtered result. The median filter does not create new unrealistic pixel values and preserves sharp edges. Also, an aliasing pixel value will not affect the filtered result. However, as the number of input pixels increases, the computational cost of sorting becomes too expensive for practical implementation.

To address such problems, some edge-oriented spatial filtering algorithms have been developed. Those algorithms, however, require expensive hardware and introduce artifacts when edge-detection fails, especially in noisy images. Other algorithms convert images into frequency domain and reduce the high frequency components. Since image details are also high frequency components, such methods also blur the images.

Temporal noise reduction first examines motion information among the current video frame and its neighboring frames. It classifies pixels into motion region and non-motion region. In non-motion region, a filter is applied to the pixels in the current frame and its neighboring frames along the temporal axis. In motion region, the temporal filter is switched off to avoid motion blurring. Generally, temporal noise reduction is better in keeping the details and preserving edges than spatial noise reduction. The filtering performance, however, depends on the number of original frames to obtain enough filtering pixels along temporal axis. For better performance, a large number of frames must be stored in memory, leading to higher hardware costs and increased computational complexity. Such disadvantages limit applicability of temporal noise reduction.

There is, therefore, a need for a noise reduction method and system that reduces image blurring utilizing temporal noise reduction while using less memory and maintaining performance.

### BRIEF SUMMARY OF THE INVENTION

The present invention addresses the above needs. In one embodiment, the present invention provides an improved temporal noise reduction method and system that uses less memory while maintaining performance in relation to conventional temporal noise reduction.

According to one embodiment of the present invention, temporal noise reduction is applied to two video frames, wherein one video frame is the current input noisy frame, and the other video frame is a previous filtered frame stored in memory. Once the current frame is filtered, it is saved into memory for filtering the next incoming frame. A motion-adaptive temporal filtering method is applied for noise reduction. Pixel-wise motion information between the current frame and the previous (filtered) frame in memory is examined. Then the pixels in the current frame are classified into motion region and non-motion region relative to the previous (filtered) frame. In a non-motion region, pixels in the current frame are filtered along the temporal axis based on the Maximum Likelihood Estimation method (the filtering output is essentially optimal). In a motion region, the temporal filter is switched off to avoid motion blurring.

Other embodiments, features and advantages of the present invention will be apparent from the following specification taken in conjunction with the following drawings.

### BRIEF DESCRIPTION OF THE DRAWINGS

FIG. 1 shows a block diagram of an embodiment of an improved temporal noise reduction system according to the present invention.

FIG. 2 shows a block diagram of an embodiment of a motion-adaptive temporal noise reducer according to the present invention.

FIG. 3 shows a block diagram of another embodiment of a motion-adaptive temporal noise reducer according to the present invention.

FIG. 4 shows a block diagram of an embodiment of a motion detector according to the present invention.

FIG. 5 shows a block diagram of an embodiment of a local difference calculator according to the present invention.

FIGS. 6A-F show examples of calculating a motion value according to the present invention.

FIG. 7 shows a block diagram of an embodiment of a motion-adaptive temporal filter according to the present invention.

FIGS. 8A-D show examples of weight adjustment according to the present invention.

### DETAILED DESCRIPTION OF THE INVENTION

According to one embodiment of the present invention, temporal noise reduction is applied to two video frames, wherein one video frame is the current input noisy frame, and the other video frame is a previous filtered frame stored in memory. Once the current frame is filtered, it is saved into memory for filtering the next incoming frame. A motion-adaptive temporal filtering method is applied for noise reduction. Pixel-wise motion information between the current frame and the previous (filtered) frame in memory is examined. Then the pixels in the current frame are classified into motion region and non-motion region relative to the previous (filtered) frame. In a non-motion region, pixels in the current frame are filtered along the temporal axis based on the Maximum Likelihood Estimation method (the filtering output is essentially optimal). In a motion region, the temporal filter is switched off to avoid motion blurring.

Referring to the drawings, preferred embodiments of the present invention are described. Initially, an analysis of Gaussian distributed signals is provided as a foundation for noise reduction according to embodiments of the present invention.

A. Analysis of the Gaussian Distributed Signal

Assume an unknown constant value p is corrupted with independent, identically distributed additive and stationary zero-mean Gaussian noise, denoted as n˜N(0, σ²). The observed value x can be defined as:
x=μ+n, (1)

which is also a Gaussian distributed random variable. The constant value μ can be estimated using Maximum Likelihood Estimation method from a certain number of observed values.

For k observed values x₁, x₂, . . . , xₖ, the likelihood function ƒₙ(x|μ) can be defined as:

$${f}_{n} ( x \text{\vert} μ ) = \frac{1}{{( 2 π {σ}^{2} )}^{k / 2}} {ⅇ}^{- \frac{1}{2 {σ}^{2}} {\sum }_{i = 1}^{k} {( {x}_{i} - μ )}^{2}} . \qquad ( 2 )$$

σ is noise standard deviation. It can be seen from relation (2) that ƒₙ(x|μ)will be maximized by the value of μ that minimizes Q(μ) as:

$$Q ( μ ) = {\sum }_{i = 1}^{k} {( {x}_{i} - μ )}^{2} = {\sum }_{i = 1}^{k} {x}_{i}^{2} - 2 μ {\sum }_{i = 1}^{k} {x}_{i} + k {μ}^{2} . \qquad ( 3 )$$

Calculating the derivative dQ(μ)/dμ, setting this derivative equal to 0, and solving the resulting equation for μ, then the Maximum Likelihood Estimation is defined as:

$${μ}_{ML} = \frac{1}{k} {\sum }_{i = 1}^{k} {x}_{i} . \qquad ( 4 )$$

The above result can also be obtained sequentially as:

$${μ}_{1} = {x}_{1} ; \\ {μ}_{k} = \frac{1}{k} {\sum }_{i = 1}^{k} {x}_{i} = \frac{{μ}_{k - 1} ( k - 1 ) + {x}_{k}}{k} . \qquad ( 5 )$$

Using recursive weight as well, relation (5) above can be modified as:

$${μ}_{1} = {x}_{1} ; \\ {w}_{1} = 1 ; \\ {μ}_{1} = \frac{{w}_{i - 1} {μ}_{i - 1} + {x}_{i}}{{w}_{i - 1} + 1} for i = 2 , 3 , ⋯ , k ; \\ {w}_{i} = {w}_{i - 1} + 1 for i = 2 , 3 , ⋯ k , \qquad ( 6 )$$

wherein, wᵢ is the optimal weight indicating the number of pixels from which the average value μᵢ is obtained. Relation (6) is advantageous because it updates the estimated value sequentially, and requires less memory than relation (4). Further, relation (4) needs to save all original data into memory to estimate μ, while relation (6) only need to save the current observed value xᵢ, previously estimated value μᵢ₋₁, and the optimal weight wᵢ₋₁.

In temporal noise reduction, it is generally assumed that the input video is corrupted by the same type of noise as in the above analysis. Therefore, each pixel can be regarded as a constant value (true pixel value) corrupted by Gaussian noise. In non-motion region, pixels along the temporal axis have the same true pixel value which thus can be optimally estimated using relation (4) or relation (6). As video frames enter the video system sequentially, relation (6) is more convenient for removing noise frame by frame, and furthermore, it substantially reduces memory requirements.

B. Improved Temporal Noise Reduction System

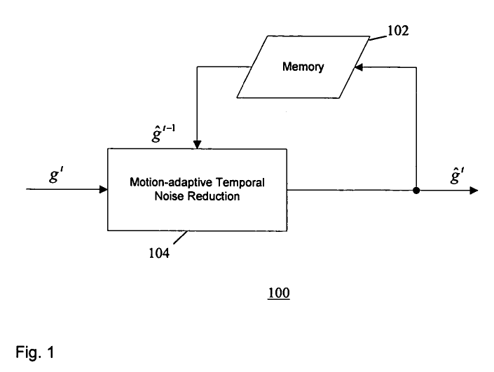

FIG. 1 shows a block diagram of an embodiment of an improved temporal noise reduction system 100 according to the present invention, comprising a memory 102 and a motion-adaptive noise reduction device 104. The motion-adaptive noise reduction device 104 operates on a current input noisy frame, denoted as gₜ, and the previous filtered frame read from memory, denoted as ĝ^{t-1}. Once the current frame is filtered, denoted as ĝ^{t}, it is saved into the memory 102 for filtering the next incoming frame. The filtered frame ĝ^{t} is also transferred to the next step of video processing. As described below, in the motion-adaptive noise reduction device 104, pixels in a motion region are filtered along the temporal axis, while pixels in a non-motion region are not filtered in order to avoid motion blurring.

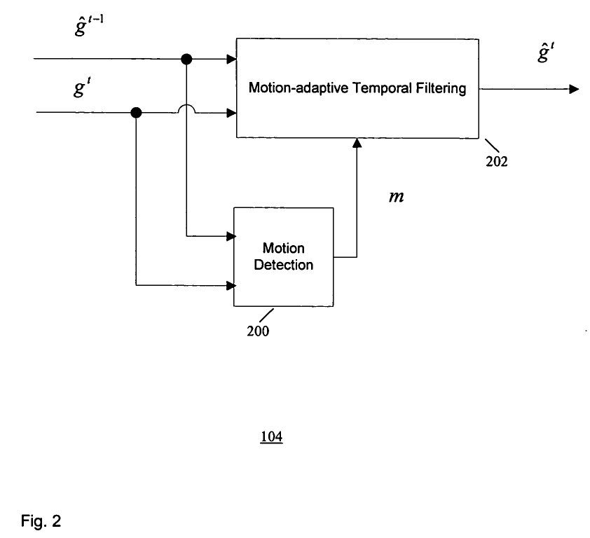

FIG. 2 shows an embodiment of the motion-adaptive reduction device 104 of FIG. 1, comprising a motion detector 200 and a motion-adaptive temporal filter 202. The motion detector 200 detects motion between the content of the current frame g^{t} and the previous filtered frame ĝ^{t-1}, to determine motion and non-motion regions in the current frame relative to the previous filtered frame.

Specifically, the motion detector 200 examines pixel-wise motion information between the two frames g^{t} and ĝ^{t-1}. The motion information m indicates if a pixel is in a motion region or a non-motion region. In motion-adaptive temporal filter 202, pixels in a non-motion region are essentially optimally filtered in the temporal domain. However, for pixels in a motion region, original pixels value are kept to avoid motion blurring.

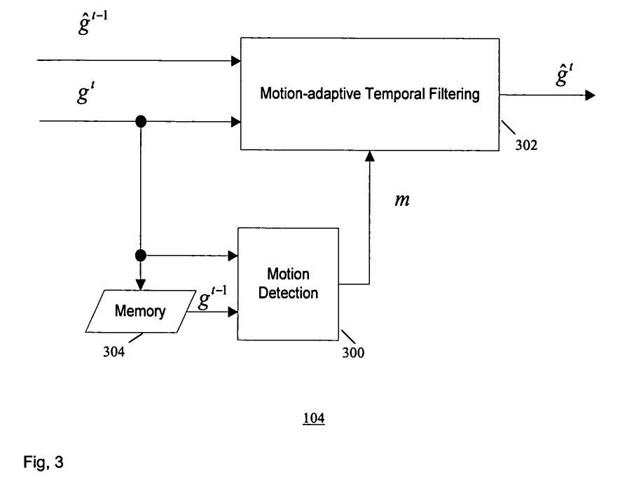

FIG. 3 shows another embodiment of the motion-adaptive reduction device 104 of FIG. 1 which is a variation of the example of FIG. 2, comprising a motion detector 300, a motion-adaptive temporal filter 302 and a memory 304. In the embodiment shown in FIG. 3, motion information is obtained between the current frame g^{t} and the previous (unfiltered) frame g^{t-1} from the memory 304. For simplicity, in the following, implementation of the embodiment in FIG. 2 is described. However, as those skilled in the art will appreciate, the following description also applies to the embodiment in FIG. 3.

Referring back to the embodiment in FIG. 2, to classify a pixel into motion or non-motion region, the motion value, m, estimated by the motion detector 200 are used to measure the motion level. For example, let motion value mε[0,1]. The larger the motion value m is, the higher the motion level.

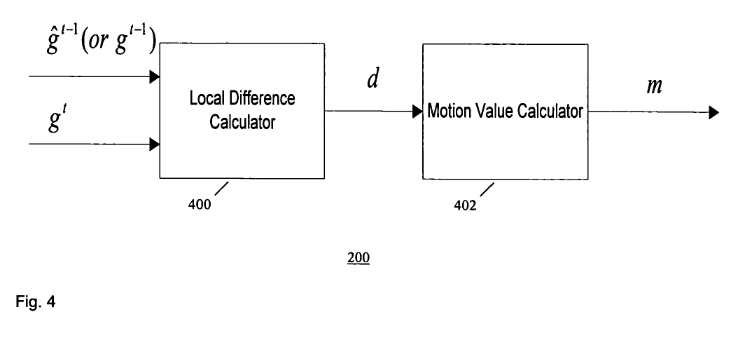

An embodiment of the motion detector 200 is shown FIG. 4, a local difference calculator 400 and a motion value calculator 402. The local difference calculator 400 computes pixel-wise local difference d between two frames g^{t} and ĝ^{t-1}. The local difference d is compared with one or more thresholds in the motion value calculator. If the difference is larger than the threshold values, a high motion value is obtained, indicating a motion region. If the difference is smaller, a low motion value is obtained, indicating a non-motion region. The motion value is a monotonically increasing function of the local difference. In this example, motion value m is also pixel-wise.

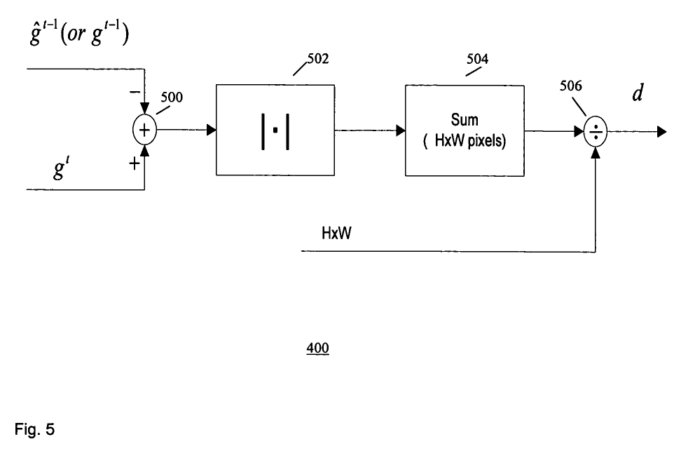

Many methods can be used to compute the local difference, such as mean absolute error (MAE), mean square error (MSE), etc. The local difference is calculated over a local window between two frames. There is no restriction to the shape of the local window (e.g., a rectangular window can be used). FIG. 5 shows a block diagram of an embodiment of the local different calculator 400 implementing MAE over a local window of size H×W pixels. The local difference calculator 400 comprises: a difference junction 500 that calculates pixel difference values by determining pixel-wise differences between the pixels in the local window in the current frame (g^{t}) and the previous frame (ĝ^{t-1} or g^{t-1}); an absolute value calculator 502 that calculates the absolute value of the pixel difference values; a summing junction 504 that calculates the sum of the pixel difference values output from the absolute value calculator 502; and a divider 506 that divides the sum by the number of pixels H×W in the local window to obtain said pixel-wise local difference d. As those skilled in the art will recognize, other implementations of the local difference calculator 400 are also possible.

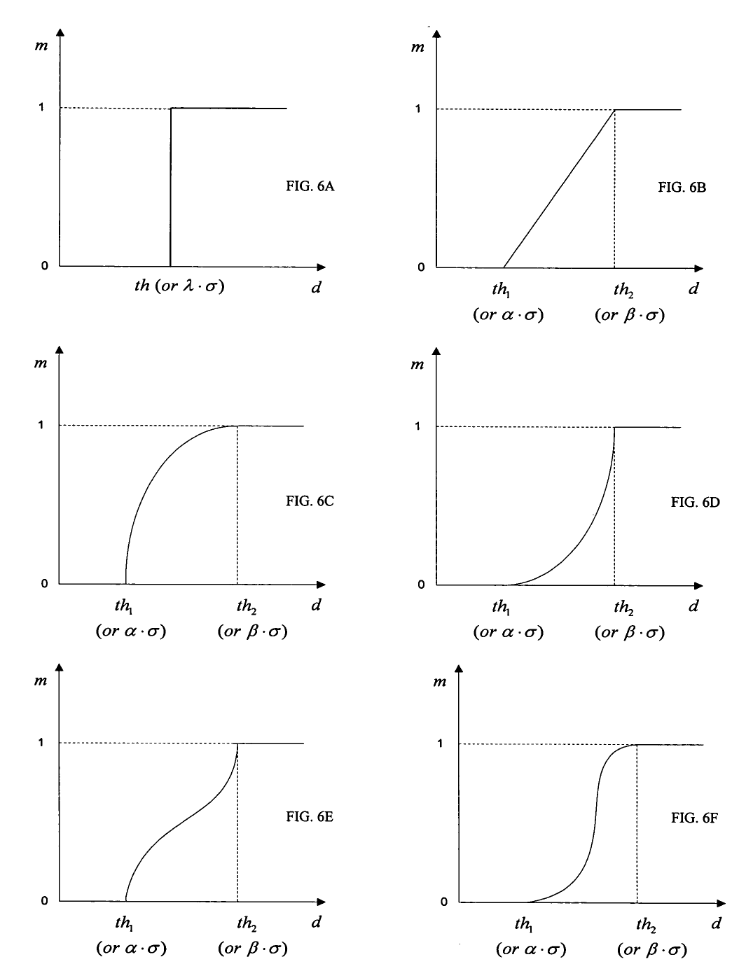

FIGS. 6A-F show six example methods of motion value (information) calculation that can be implemented by the motion value calculator 400. The example method in FIG. 6A computes a hard-switching motion value. The local difference d is compared with a threshold th. If the local difference d is larger than the threshold th, there is no motion (e.g., m=0), otherwise there is motion (e.g., m=1).

The example method of FIG. 6A is extended to compute soft-switching motion value m as shown in FIGS. 6B-F. Soft-switching motion value calculation often provides smoother motion information. If the local difference d is smaller than a threshold th₁, there is no motion (e.g., m=0). If the local difference d is larger than another threshold th₂, then there is motion (e.g., m=1). If the local difference d is in between th₁ and th₂, then: (1) the motion value m can be linearly interpolated, as shown by example in FIG. 6B, or (2) the motion value m can be non-linearly interpolated as shown by example in FIGS. 6C-F.

There is no restriction on computing the motion value m, as long as it is a monotonically increasing function of the local difference d. If the noise variance σ² is already known, manually set or pre-detected by a separate noise estimation unit (not shown), the motion value calculation can be extend to noise-adaptive methods. The various thresholds th, th₁ and th₂ can be a product of: (i) constant values (e.g., λ, α and β in FIGS. 6A-F) and (ii) the noise standard deviation. In that case, motion value calculation is more robust against noise because the thresholds are automatically adjusted by the noise.

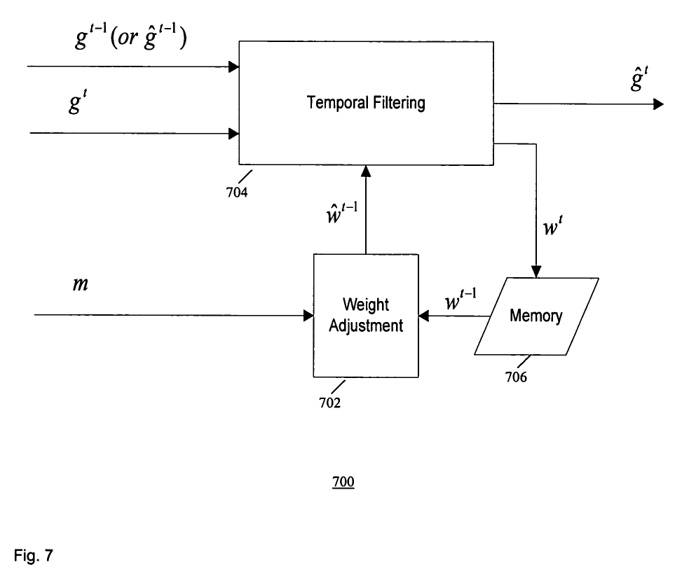

To remove the noise in pixel at row i, column j of frame g^{t}, in one example the weighted average of pixels g_{i,j}^{t} and ĝ_{i,j}^{t-1} can be computed as the filtered output. If the pixel is in a motion region, the filtered pixel ĝ_{i,j}^{t} equals to the original value g_{i,j}^{t} (i.e., weights 1 and 0 are assigned to pixels g_{i,j}^{t} and ĝ_{i,j}^{t-1}, respectively). If there is no motion, relation (6) above can be applied to obtain optimal filtering performance. FIG. 7 shows a block diagram of an example motion-adaptive temporal filtering device 700 in which such noise reduction method is implemented, comprising a weight adjustment unit 702, a temporal filtering unit 704 and memory 706.

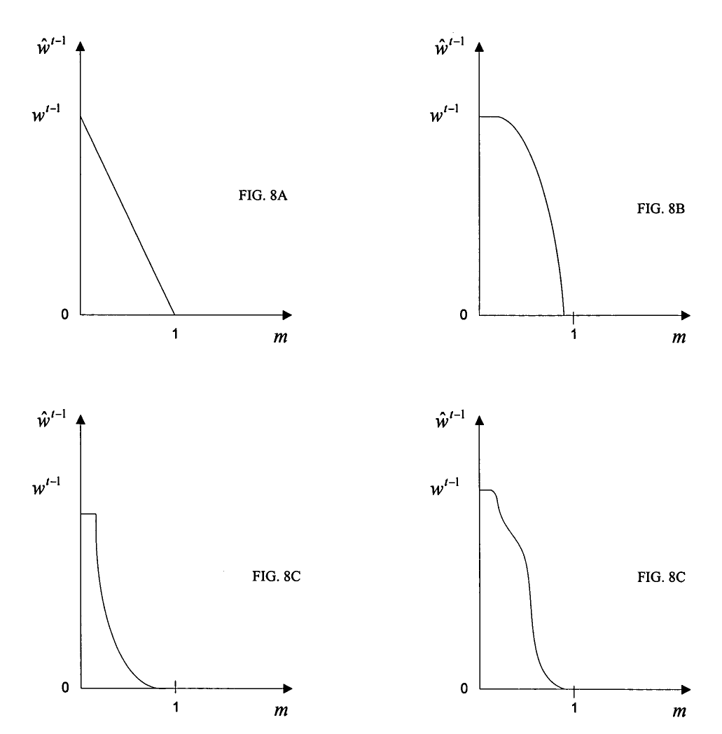

The weight adjustment unit 702 determines the value ŵ^{t-1} as the weight of pixel ĝ_{i,j}^{t-1} based on the motion value m. FIGS. 8A-D show four example weight adjustment methods that can be implemented in the weight adjustment unit 702. In general, if there is motion (m=1), then ŵ^{t-1} is set to 0. If there is motion (m=0), then ŵ^{t-1} is set to the optimal weight w^{t-1} (obtained from the memory 706), wherein relation (6) is utilized. If the motion value m is between 0 and 1, then: (i) the value ŵ^{t-1} can be linearly interpolated, as shown by example in FIG. 8A, or (ii) the value ŵ^{t-1} can be non-linearly interpolated as shown by examples in FIGS. 8B-D, to generate a smooth output. There is no restriction on determining ŵ^{t-1} as long as ŵ^{t-1} is a monotonically decreasing function of the motion value m.

As mentioned before, the final output is the weighted average of pixels g_{i,j}^{t} and ĝ_{i,j}^{t-1}. Referring back to FIG. 7, in one embodiment the temporal filtering unit 704 implements relation (7) below is used to obtain the final filtered output:

$${\hat{g}}_{i , j}^{t} = \frac{{\hat{w}}^{t - 1} {\hat{g}}_{i , j}^{t - 1} + {g}_{i , j}^{t - 1}}{{\hat{w}}^{t - 1} + 1} . \qquad ( 7 )$$

The optimal weight is updated according to relation (8) below:
w^{t}=ŵ^{t-1}+1. (8)

The filtered pixel and optimal weight are saved in memory for filtering the next incoming frame as discussed above.

Simulations have shown that if the optimal weight is too large, artifacts such as motion blurring will occur. Therefore, a maximum value wₘₐₓ can be set which can not be exceeded by the updated optimal weight. As such, relation (8) is modified as:
w^{t}=min(wₘₐₓ,ŵ^{t-1}+1). (9)

As those skilled in the art will recognize, the present invention can be used on both progressive and interlaced videos. The even and odd fields in an interlaced video can be processed as two separate progressive video sequences; or the fields can be merged into a single frame prior to be processed.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of reducing noise in a sequence of digital video frames, comprising the steps of:
(a) reducing noise in a current noisy frame by performing motion-adaptive temporal noise reduction based on the current noisy frame and a previous noise-reduced frame; and
(b) saving the current noise-reduced frame into memory for filtering the next frame in the sequence.

2. The method of claim 1 further including the steps of repeating steps (a) and (b) for the next video frame in the sequence.

3. the method of claim 1 wherein step (a) further includes the steps of:
detecting motion between the current noisy frame and the previous noise-reduced frame to generate motion information; and
performing temporal filtering on the current noisy frame as a function of the motion information.

4. The method of claim 3 wherein the step of detecting motion further includes the steps of performing pixel-wise motion between the current noisy frame and the previous noise-reduced frame.

5. The method of claim 4 wherein the step of detecting motion further includes the steps of performing pixel-wise motion detection in a local window in the current noisy frame relative to a corresponding local window in the previous noise-reduced frame.

6. The method of claim 5 wherein the step of performing pixel-wise motion detection further includes the steps of calculating a pixel-wise local difference d between the current noise frame and the previous noise-reduced frame.

7. The method of claim 6 wherein the step of calculating the local difference d further includes the steps of performing pixel-wise mean absolute error (MAE) calculations in the local windows.

8. The method of claim 7 wherein the step of performing MAE calculations further includes the steps of:
calculating pixel difference values by determining pixel-wise differences between the pixels in the local window in the current noisy frame and the previous noise-reduced frame;
calculating the absolute value of the pixel difference values;
calculating the sum of the pixel difference values from the absolute value calculation; and
dividing the sum by the number of pixels in the local window to obtain said pixel-wise local difference d

9. The method of claim 6 wherein the step of calculating the local difference d further includes the steps of performing mean square error (MSE) calculations in the local windows.

10. The method of claim 6 further including the step of calculating said motion information m by comparing the local d to one or more threshold values indicating motion.

11. The method of claim 10 wherein the motion information is a monotonically increasing function of the local difference d.

12. The method of claim 10 wherein at least one threshold value is a function of noise standard deviation.

13. The method of claim 3 wherein the step of performing temporal filtering further includes the steps of: if motion is not detected for a pixel in the current noisy frame, performing temporal filtering for the pixel along the temporal axis.

14. The method of claim 13 further including the steps of performing said temporal filtering for the pixel along the temporal axis using a maximum likelihood estimation process.

15. The method of claim 13 wherein the step of performing temporal filtering further includes the steps of: if motion is detected for a pixel in the current noisy frame, maintaining the pixel characteristics to avoid motion blurring.

16. The method of claim 3, wherein the steps of detecting motion further includes the steps of detecting motion between the current noisy frame and the previous noisy frame.

17. A noise reduction system for reducing in a sequence of digital video frames, comprising:
(a) a motion-adaptive noise reducer that reduces noise in a current noisy frame by performing motion-adaptive temporal noise reduction based on the current noisy frame and a previous noise-reduced frame; and
(b) memory for saving the current noise-reduced frame into memory for filtering the next frame in the sequence.

18. The system of claim 17 wherein the motion-adaptive noise reducer comprises:
a motion detector that detects motion between the current noisy frame and the previous noise-reduced frame to generate motion information; and
a temporal filter that performs temporal filtering on the current noisy frame as a function of the motion information.

19. The system of claim 18 wherein the motion detector further performs pixel-wise motion between the current noisy frame and the previous noise-reduced frame.

20. The system of claim 19 wherein the motion detector further performs pixel-wise motion detection in a local window in the current noisy frame relative to a corresponding local window in the previous noise-reduced frame.

21. The system of claim 20 wherein the motion detector comprises a local difference calculator that calculates a pixel-wise local difference d between the current noise frame and the previous noise-reduced frame.

22. The system of claim 21 the local difference calculator calculates the local difference d further by performing pixel-wise mean absolute error (MAE) calculations in the local windows.

23. The system of claim 22 wherein local difference calculator comprises:
a differencing means that calculates pixel difference values by determining pixel-wise differences between the pixels in the local window in the current noisy frame and the previous noise-reduced frame;
an absolute value means that calculates the absolute value of the pixel difference values;
a summing means that calculates the sum of the pixel difference values from the absolute value calculation; and
a dividing means that divides the sum by the number of pixels in the local window to obtain said pixel-wise local difference d.

24. The system of claim 21 wherein the local difference calculator calculates the local difference d by performing mean square error (MSE) calculations in the local windows.

25. The system of claim 21 wherein the motion detector further includes a motion value calculator that calculates said motion information m by comparing the local d to a threshold value indicating motion.

26. The system of claim 25 wherein the motion information is a monotonically increasing function of the local difference d.

27. The system of claim 25 wherein the threshold value is a function of noise standard deviation.

28. The system of claim 18 wherein the temporal filter performs temporal filtering for a pixel along the temporal axis if motion is not detected for that pixel in the current noisy frame.

29. The system of claim 28 wherein the temporal filter performs said temporal filtering for the pixel along the temporal axis using a maximum likelihood estimation process.

30. The system of claim 18 wherein the motion detector detects motion between the current noisy frame and the previous noisy frame.
